(19) United States
(12) Patent Application Publication
(10) Pub. No.: US 2025/0172114 A1
(43) Pub. Date: May 29, 2025

(54) METHOD, COMPUTING UNIT AND COMPUTER PROGRAM FOR ASCERTAINING A WEAR STATE OF AT LEAST ONE FUEL INJECTOR

(71) Applicant: Robert Bosch GmbH, Stuttgart (DE)

(72) Inventor: Oliver Schmid, Stuttgart (DE)

(21) Appl. No.: 18/947,332

(22) Filed: Nov. 14, 2024

(30) Foreign Application Priority Data
Nov. 23, 2023 (DE) 10 2023 211 704.5

(51) Int. Cl. F02M 65/00

(52) U.S. Cl. CPC F02M 65/003

(57) ABSTRACT

A method for ascertaining a wear state of at least one fuel injector for an internal combustion engine, and a computing unit and a computer program for carrying out the method. In the method, a pressure gradient in the high-pressure fuel reservoir resulting from an injection by the at least one fuel injector is ascertained, and, if the ascertained pressure gradient falls below a predetermined threshold value, an undershoot counter of the at least one fuel injector is incremented, an undershoot time is ascertained, during which the pressure gradient resulting from the injection by the at least one fuel injector remains below the predetermined threshold value; and a wear state of the at least one fuel injector is determined on the basis of a value of its undershoot counter and a value of its undershoot time.

### FIELD

The present invention relates to a method for ascertaining a wear state of at least one fuel injector for an internal combustion engine, and to a computing unit and a computer program for carrying out the method.

### BACKGROUND INFORMATION

Aging effects, such as coking, on fuel injectors of an injection system for an internal combustion engine can lead to extended injection times of the affected fuel injector, which can result in increased exhaust emissions from the internal combustion engine. It is therefore desirable to detect such aging effects at an early stage and replace the affected fuel injector.

German Patent Application No. DE 10 2018 219232 A1 describes a method for detecting a late-closing fuel injector in a fuel injection system of an internal combustion engine on the basis of a pressure gradient in a high-pressure fuel reservoir after actuation of the fuel injector.

In order to determine the severity of aging/wear on a fuel injector and, on the basis of this, to set a replacement time for the injector, the pressure gradient in the high-pressure fuel reservoir must be specifically ascertained and analyzed.

### SUMMARY

According to the present invention provides a method for ascertaining a wear state of at least one fuel injector for an internal combustion engine that is connected to a high-pressure fuel reservoir and a computing unit and a computer program for carrying out the method. Advantageous example embodiments of the present invention are disclosed herein.

The present invention makes it possible to ascertain the severity of the wear of individual fuel injectors of an injection system and, on the basis of this, to predictively determine their replacement time. In this way, failure of one or more fuel injectors during operation of the internal combustion engine can be avoided.

In example embodiments of the present invention, the internal combustion engine can be a diesel engine or a gasoline engine. In example embodiments of the present invention, the fuel injector can be part of a high-pressure injection system that also has a high-pressure fuel reservoir and a high-pressure pump (so-called common rail system). In particular, a pressure sensor for measuring fuel pressure can be installed in the high-pressure fuel reservoir. In particular, the high-pressure injection system can have a plurality of fuel injectors.

In the method according to an example embodiment of the present invention, a pressure gradient in the high-pressure fuel reservoir resulting from an injection by the at least one fuel injector is ascertained, that is to say a pressure gradient in the high-pressure fuel reservoir occurring because of an injection by the at least one fuel injector. The pressure gradient can be ascertained, for example, by numerically differentiating the measured fuel pressure curve in the high-pressure fuel reservoir. Depending on the distance and unit of the distance between the values pressure (n) and pressure (n+1) used, the gradient (dp) can also be the pressure drop (Δp), i.e., the numerical difference between the pressure before injection and the pressure after injection. The pressure drop results as a gradient of a non-temporal, but unitless curve in which the pressure measurement values are stored one after the other without any reference to time. A time reference or angle reference is also possible, e.g., ° KW or ° NW.

If a plurality of fuel injectors are present in the high-pressure injection system, the fuel injectors can be actuated according to a predetermined injection sequence. In this case, the ascertained pressure gradient in the high-pressure fuel reservoir can be assigned to a fuel injector that was actuated last.

If the pressure gradient falls below a predetermined threshold value, an undershoot counter of the at least one fuel injector is incremented. In particular, the undershoot counter can be incremented each time the pressure gradient is below the predetermined threshold value. In this way, a value of the undershoot counter can increase with each ascertained pressure gradient below the predetermined threshold value. In other words, it can be used to monitor whether the amount of fuel injected is too large.

According to one example embodiment of the present invention, the predetermined threshold value for the pressure gradient can be set depending on an operating point of the internal combustion engine and/or a design of the at least one fuel injector. For example, a target pressure drop in the high-pressure reservoir can be determined on the basis of a target injection quantity of the at least one fuel injector for each operating point of the internal combustion engine, and the predetermined threshold value can be set by means of an offset to the target pressure drop. When determining the offset, a fuel pressure in the high-pressure reservoir and the speed of the internal combustion engine can be taken into account, for example. Alternatively or additionally, the design of the at least one fuel injector can be taken into account, for example by taking into account flow characteristics of its nozzle, in setting the predetermined threshold value. In other words, it can be used to determine how steep or how great the pressure drop would normally have to be when opening or injecting in the specific use case.

Subsequently, an undershoot time is ascertained, during which the pressure gradient resulting from the injection by the at least one fuel injector remains below the predetermined threshold value. The undershoot time can be ascertained, for example, when the pressure gradient has exceeded the predetermined threshold value again. In other words, a period of time during which the ascertained pressure gradient remains below the predetermined threshold value after incrementation of the undershoot counter can be ascertained as the undershoot time for the relevant injection. In other words, it can be used to determine how long too much is being injected.

If the undershoot counter is incremented again during a subsequent injection, a further undershoot time is ascertained. According to one embodiment, this can be added to the previous undershoot time and in this way a value of the undershoot time of the at least one fuel injector can be determined. In other words, the value of the undershoot time can be calculated by summing undershoot times for different injections.

On the basis of a value of the undershoot counter and a value of the undershoot time, a wear state of the at least one fuel injector is then determined. Thus, the wear state of the at least one fuel injector can be deduced on the basis of the frequency or duration of an increased pressure drop in the high-pressure fuel reservoir caused by an injection by the at least one fuel injector. In particular, both a high frequency and a long duration indicate wear.

According to one example embodiment of the present invention, at least one relationship between the value of the undershoot counter and/or the value of the undershoot time and the wear state of the at least one fuel injector can be determined and stored in advance. The specific relationship can be stored in a computing unit, which can in particular be a control unit of the internal combustion engine.

To determine the at least one relationship, for example, a value of the undershoot counter and/or the undershoot time of one or more reference fuel injectors can be ascertained continuously, e.g., during an endurance test on a test bench. Selected reference fuel injectors can be, for example, injectors with injection characteristics that are within a predetermined tolerance range when new.

It is also possible to use fuel injectors with injection characteristics from different tolerance ranges and to ascertain a relationship for each tolerance range. Different relationships between the value of the undershoot counter and/or the value of the undershoot time and the wear state of the reference fuel injectors can also be ascertained by different boundary conditions (fuel pressure and fuel temperature, injection profile, frequency of injection, multiple injection, etc.) during the endurance test.

In this way, a relationship between the value of the undershoot counter/undershoot time and the wear state can be determined in each case both for fuel injectors with different injection behavior when new and for different operating conditions of the injectors.

The one or more reference fuel injectors can each be assessed when certain values of the undershoot counter and/or the undershoot time are reached in order to ascertain their wear state. In this way, each specific value of the undershoot counter and/or the undershoot time can be assigned a wear state of the reference fuel injector(s). If multiple fuel injectors are used, an average or maximum wear state of all injectors assessed can be determined, for example.

A wear state can be understood to mean, for example, a build-up of coking on a nozzle needle of a fuel injector. Another wear state could be, for example, cavitation erosion on the nozzle needle and in the nozzle holes of the fuel injector. Such wear states can be detected and quantified by visual inspection or by measurement (e.g., thickness of the coking layer, thickness of material removal due to cavitation erosion).

In particular, the endurance test can be carried out in such a way that the reference fuel injectors reach the end of their service life during this test in order to be able to ascertain a value of the undershoot counter and/or the undershoot time for this final wear state (defect). In this way, a defect of the at least one fuel injector can be determined, depending on the specific wear state, on the basis of a value of the undershoot counter and/or the undershoot time.

According to one example embodiment of the present invention, a replacement time of the at least one fuel injector can be determined depending on the determined wear state. This can be done, for example, on the basis of the specific relationship between the value of the undershoot counter and/or the undershoot time and the wear state. Since, on the basis of this relationship, a curve of the wear state of the at least one fuel injector as a function of the value of the undershoot counter/the undershoot time until its service life is reached is known, a period until the end of its service life can be determined on the basis of the currently ascertained wear state and the current action time of the injector.

According to one example embodiment of the present invention, a cause of wear can be determined on the basis of a curve of the wear state of the at least one fuel injector. In particular, the different wear states described above can result in a different injection behavior of the at least one fuel injector, which can be detected by means of the associated pressure gradients in the high-pressure fuel reservoir. For example, increasing coking of the nozzle needle can cause the fuel injector increasingly to close late, resulting in an increase in the frequency of an impermissibly high pressure drop and thus the value of the undershoot counter. Consequently, in this case, the cause of the wear can be deduced on the basis of a curve of the values of the undershoot counter, which here represent the curve of the wear state of the at least one fuel injector.

A computing unit according to the present invention, e.g., a control unit of the internal combustion engine, is configured, in particular in terms of programming, to carry out a method according to the present invention.

Furthermore, the implementation of a method according to an example embodiment of the present invention in the form of a computer program or computer program product having program code for carrying out all the method steps is advantageous because it is particularly low-cost, in particular if an executing control unit is also used for further tasks and is therefore present anyway. Suitable data carriers for providing the computer program are, in particular, magnetic, optical, and electric storage media, such as hard disks, flash memory, EEPROMs, DVDs, and others. It is also possible to download a program via computer networks (Internet, intranet, etc.).

Further advantages and embodiments of the present invention can be found in the description herein and the figures.

Of course, the features mentioned above and those still to be explained below can be used not only in the respectively specified combinations, but also in other combinations or alone, without departing from the scope of the present invention.

The present invention is illustrated schematically in the figures on the basis of exemplary embodiments and is described in detail below with reference to the figures.

### BRIEF DESCRIPTION OF THE DRAWINGS

FIG. 1 schematically shows an injection system with multiple fuel injectors, the wear state of which can be determined by means of an exemplary embodiment of the method according to the present invention.

FIG. 2 schematically shows a block diagram by means of which an exemplary embodiment of the method according to the present invention can be implemented in a computing unit.

FIG. 3 schematically shows a measurement of multiple input and output variables of the block diagram shown in FIG. 2.

### DETAILED DESCRIPTION OF EXAMPLE EMBODIMENTS

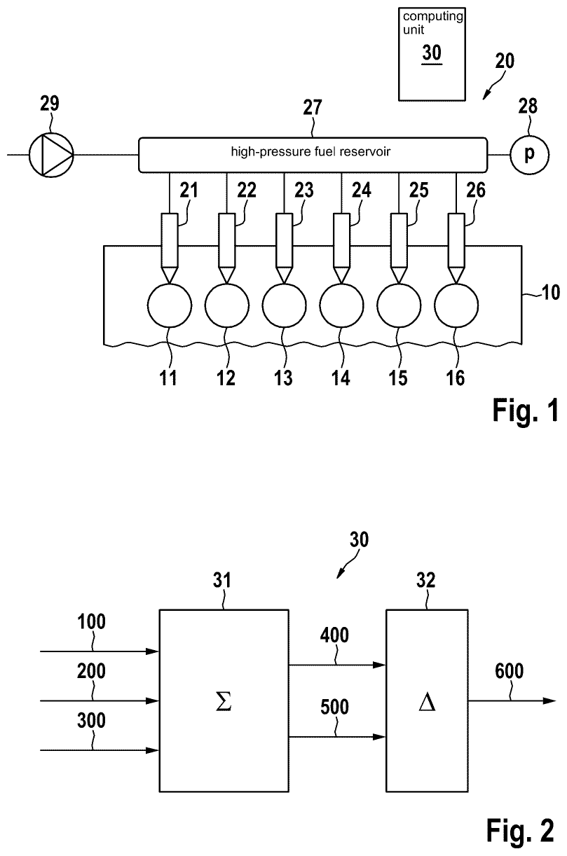

FIG. 1 schematically shows an injection system 20 (common rail system) with multiple fuel injectors 21-26, the wear state of which can be determined by means of an exemplary embodiment of the method according to the present invention. The fuel injectors 21-26 are each assigned to a cylinder 11-16 of an internal combustion engine (not shown in detail) and inject directly into it. The internal combustion engine can in particular be a diesel engine.

The injection system 20 further comprises a high-pressure fuel pump 29 and a high-pressure fuel reservoir 27, in which a pressure sensor 28 is mounted, as well as a computing unit 30. The high-pressure fuel pump 29 pumps fuel, in particular diesel fuel, into the high-pressure fuel reservoir 27, from which the fuel injectors 21-26 are supplied with fuel. Each injection of an injector 21-26 results in a pressure drop in the high-pressure fuel reservoir 27, which can be detected by means of the pressure sensor 28 and correlates with an injected fuel quantity. A pressure gradient of the fuel pressure in the high-pressure reservoir 27 can be ascertained, for example, by numerically differentiating the measured temporal pressure value curve. Alternatively, the pressure drop caused by the injection, i.e., the numerical difference between the pressure before injection and the pressure after injection, can be determined as the pressure gradient. This results as a gradient of a non-temporal, but unitless curve in which the pressure measurement values are stored one after the other without any reference to time.

If wear, such as coking or cavitation, occurs on one or more fuel injectors 21-26, this can result in an increased injection quantity and thus an increased pressure drop/pressure gradient in the high-pressure fuel reservoir 27, which can be detected by means of the pressure sensor 28. The fuel injectors 21-26 can be actuated according to a predetermined injection sequence, which corresponds in particular to the ignition sequence of the internal combustion engine, and the ascertained pressure gradient in the high-pressure fuel reservoir 27 can be assigned to a fuel injector 21-26 that was actuated last.

If the ascertained pressure gradient falls below a predetermined threshold value, an undershoot counter of the relevant fuel injector 21-26 is incremented. The predetermined threshold value for the pressure gradient (pressure drop) can be set, for example, depending on an operating point of the internal combustion engine and/or a design of the at least one fuel injector 21-26.

Subsequently, an undershoot time is ascertained, during which the pressure gradient resulting from the injection by the relevant fuel injector 21-26 remains below the predetermined threshold value. The undershoot time can be ascertained, for example, when the pressure gradient has exceeded the predetermined threshold value again. In other words, a period of time during which the ascertained pressure gradient remains below the predetermined threshold value after incrementation of the undershoot counter can be ascertained as the undershoot time for the relevant injection.

If the undershoot counter is incremented again during a subsequent injection by the relevant fuel injector 21-26, a further undershoot time is ascertained. This can be added to the previous undershoot time, for example, and in this way a value of the undershoot time of this fuel injector 21-26 can be determined.

On the basis of a value of the undershoot counter and/or a value of the undershoot time, a wear state of the fuel injector 21-26 is then determined. In this way, the frequency and/or duration of an increased pressure drop in the high-pressure fuel reservoir 27, which can be assigned to a fuel injector 21-26 that was actuated last, can be used to deduce wear of this injector. The actuation of the fuel injectors 21-26 and the determination of their wear states can be carried out by the computing unit 30 shown, which can in particular be a control unit of the internal combustion engine.

FIG. 2 schematically shows a block diagram by means of which an exemplary embodiment of the method according to the present invention can be implemented, for example in the computing unit 30 shown in FIG. 1.

For this purpose, the computing unit 30 comprises a first and a second functional block 31, 32, which each receive input variables, perform calculations and output variables.

The first function block 31 receives a cylinder counter 100, a time 200 and a pressure gradient 300 determined from the measured fuel pressure as input variables and calculates therefrom a value of the undershoot counter 400 and a value of the undershoot time 500 for a fuel injector 21-26, which is indicated by the cylinder counter 100 as the last actuated injector 21-26.

In the first function block, for example, a value of the undershoot counter 400 of the displayed fuel injector 21-26 is incremented whenever the pressure gradient 300 falls below the predetermined threshold value. From this point in time (first point in time), which can be determined on the basis of the incoming time 200, an undershoot time is determined for a current injection by the displayed fuel injector 21-26. The determination can be made, for example, when the pressure gradient 300 again exceeds the predetermined threshold value. This point in time (second point in time) can also be ascertained from the incoming time 200. The undershoot time for the current injection by the displayed fuel injector 21-26 can then be calculated, for example, by subtracting the first time from the second time. If the undershoot counter 400 for this fuel injector 21-26 is incremented again, a further undershoot time of the displayed fuel injector 21-26 can be ascertained and added to the previously ascertained undershoot time. In this way, a value of the undershoot time 500 can also be continuously ascertained for each fuel injector 21-26.

The second function block 32 receives the value of the undershoot counter 400 and the value of the undershoot time 500 of each fuel injector 21-26 from the first function block 31 and ascertains therefrom, for example, a wear state of the individual fuel injectors 21-26. For this purpose, at least one relationship between the value of the undershoot counter 400 and/or the value of the undershoot time 500 and the wear state can be stored in the second function block 32, for example.

To determine the at least relationship, for example, a value of the undershoot counter and/or the undershoot time of one or more reference fuel injectors can be ascertained continuously, e.g., during an endurance test on a test bench. The one or more reference fuel injectors can each be assessed when certain values of the undershoot counter and/or the undershoot time are reached in order to ascertain their wear state. In particular, the endurance test can be carried out in such a way that the reference fuel injectors reach the end of their service life during the test. This final wear state can also be correlated with the corresponding value of the undershoot counter 400 and/or the undershoot time 500. In this way, each specific value of the undershoot counter 400 and/or the undershoot time 500 can be assigned a wear state of the reference fuel injector(s). If multiple fuel injectors are used, an average or maximum wear state of all injectors assessed can be determined, for example. These ascertained values of the wear state and the incremented counter readings of the undershoot counters (including assignment to the individual injectors) are stored in the computing unit 30.

On the basis of this relationship ascertained in this way, a wear state can be ascertained for each of the fuel injectors 21-26 shown and, for example, a replacement time of an injector 21-26 can be determined.

FIG. 3 shows a measurement of multiple input and output variables of the block diagram shown in FIG. 2. In particular, the pressure gradient 300 as well as the value of the undershoot counter 400 and the undershoot time 500 of an individual fuel injector 21-26 are plotted against time 200. In addition, the threshold value 350 for the pressure gradient 300 is shown; if the pressure gradient falls below this threshold, the value of the undershoot counter 400 is incremented and a further undershoot time 500 is ascertained, by which the value of the undershoot time 500 is increased.

It becomes clear that in the present case the affected fuel injector 21-26 exhibits increased wear, since a plurality of pressure drops 300 below the threshold value 350 occur, which lead to a rapid increase in both the value of the undershoot counter 400 and the value of the undershoot time 500. The curve of the two values 400, 500 can be compared, for example, with the at least one relationship stored in the function block 32, and on the basis of the comparison it can be determined, for example, when the fuel injector 21-26 should be replaced at the latest in order to preempt its failure.

1-10. (canceled)

11. A method for ascertaining a wear state of at least one fuel injector for an internal combustion engine that is connected to a high-pressure fuel reservoir, comprising the following steps:
ascertaining a pressure gradient in the high-pressure fuel reservoir resulting from an injection by the at least one fuel injector;
based on the ascertained pressure gradient fallings below a predetermined threshold value:
incrementing an undershoot counter of the at least one fuel injector,
ascertaining an undershoot time during which the pressure gradient resulting from the injection by the at least one fuel injector remains below the predetermined threshold value, and
determining a wear state of the at least one fuel injector based on a value of the undershoot counter of the at least one fuel injector and a value of the undershoot time.

12. The method according to claim 11, wherein the value of the undershoot time of the at least one fuel injector is calculated by summing undershoot times for different injections.

13. The method according to claim 11, wherein a replacement time of the at least one fuel injector s determined depending on the determined wear state.

14. The method according to claim 11, wherein a defect of the at least one fuel injector is determined depending on the determined wear state.

15. The method according to claim 11, wherein a cause of the wear is determined on based on a curve of the wear state of the at least one fuel injector.

16. The method according to claim 11, wherein at least one relationship between the value of the undershoot counter and/or the value of the undershoot time and the wear state of the at least one fuel injector is determined and stored in advance.

17. The method according to claim 11, wherein the predetermined threshold value is set depending on an operating point of the internal combustion engine and/or a design of the at least one fuel injector.

18. A computing unit comprising:
a processor that is configured to ascertain a wear state of at least one fuel injector for an internal combustion engine that is connected to a high-pressure fuel reservoir, the processor configured to:
ascertain a pressure gradient in the high-pressure fuel reservoir resulting from an injection by the at least one fuel injector;
based on the ascertained pressure gradient fallings below a predetermined threshold value:
increment an undershoot counter of the at least one fuel injector,
ascertain an undershoot time during which the pressure gradient resulting from the injection by the at least one fuel injector remains below the predetermined threshold value, and
determine a wear state of the at least one fuel injector based on a value of the undershoot counter of the at least one fuel injector and a value of the undershoot time.

19. A non-transitory computer-readable data carrier on which is stored a computer program for ascertaining a wear state of at least one fuel injector for an internal combustion engine that is connected to a high-pressure fuel reservoir, the computer program, when executed by a computer, causing the computer to perform the following steps:
ascertaining a pressure gradient in the high-pressure fuel reservoir resulting from an injection by the at least one fuel injector;
based on the ascertained pressure gradient fallings below a predetermined threshold value:
incrementing an undershoot counter of the at least one fuel injector,
ascertaining an undershoot time during which the pressure gradient resulting from the injection by the at least one fuel injector remains below the predetermined threshold value, and
determining a wear state of the at least one fuel injector based on a value of the undershoot counter of the at least one fuel injector and a value of the undershoot time.
